(19) United States
(12) Patent Application Publication
(10) Pub. No.: US 2014/0038068 A1
(43) Pub. Date: Feb. 6, 2014

(54) METHOD FOR RECOVERING PERFORMANCE OF FUEL CELL

(71) Applicant: HYUNDAI MOTOR COMPANY, Seoul (KR)

(72) Inventors: Hwan Soo Shin, Uiwang (KR); Hyun Suk Choo, Hwaseong (KR); Jae Hyuk Lee, Hwaseong (KR); Sung Keun Lee, Suwon (KR)

(73) Assignee: HYUNDAI MOTOR COMPANY, Seoul (KR)

(21) Appl. No.: 13/686,318

(22) Filed: Nov. 27, 2012

(30) Foreign Application Priority Data
Aug. 1, 2012 (KR) 10-2012-0084329

(51) Int. Cl. H01M 8/04

(52) U.S. Cl. CPC H01M 8/04
USPC 429/408

(57) ABSTRACT

Disclosed is a method for recovering performance of a fuel cell, which can recover the catalytic properties of a cathode in a reusable state by supplying hydrogen to the cathode of a degraded fuel cell stack for a predetermined period of time and storing the fuel cell stack for a predetermined period of time such that an oxide formed on the surface of platinum (Pt) is removed and, at the same time, the platinum is re-precipitated.

### CROSS-REFERENCE TO RELATED APPLICATION

This application claims under 35 U.S.C. §119(a) the benefit of Korean Patent Application No. 10-2012-0084329 filed Aug. 1, 2012, the entire contents of which are incorporated herein by reference.

### BACKGROUND

(a) Technical Field

The present invention relates to a method for recovering performance of a fuel cell. More particularly, it relates to a method for recovering performance of a fuel cell, which can to partially recover the performance of a degraded polymer electrolyte fuel cell.

(b) Background Art

A typical fuel cell stack includes a membrane electrode assembly (MEA) which includes a polymer electrolyte membrane, through which hydrogen ions are transported, and an electrode/catalyst layer including a cathode and an anode, which are disposed on both sides of the polymer electrolyte membrane so that hydrogen reacts with oxygen. Moreover, a gas diffusion layer (GDL) and a gasket are sequentially stacked on the outside of the electrolyte membrane, i.e., on the outside where the cathode and the anode are positioned. Furthermore, a separator including flow fields, through which fuel is supplied and water produced by the reaction is discharged, is positioned on the outside of the GDL, thus forming a unit cell.

Accordingly, an oxidation reaction of hydrogen takes place at the anode of the fuel cell stack, and thus the hydrogen supplied to the anode is dissociated into hydrogen ions (protons, H⁺) and electrons (e⁻). The hydrogen ions are transmitted to the cathode through the electrolyte membrane and the separator, and the electrons are transmitted to the cathode through the GDL and the separator. At the cathode, an electrochemical reaction in which the hydrogen ions and electrons transmitted from the anode and oxygen in the air participate takes place to produce water and generate electrical energy from the flow of electrons.

The anode and the cathode of the fuel cell stack include carbon and platinum. In particular, deterioration of the carbon and platinum after a certain time of operation that has been known to reduce the performance of the fuel cell stack. The electrochemical surface area (ECSA) of a platinum catalyst is reduced due to the aggregation of nanoparticles or the release of platinum during the operation of the fuel cell, and thus the oxygen reduction reaction (ORR) rate of the cathode is reduced, thus causing a reduction in the entire performance of the fuel cell. However, the reduction in performance due to the deterioration of platinum and carbon is typically understood by those skilled in the art as an irreversible degradation, and thus no method for recovering the performance has been reported to date.

The typical degradation of the fuel cell electrolyte membrane will now be described with reference to FIG. 1. The degradation may be caused by a decrease in CO tolerance of catalyst at the anode due to Ru decomposition, a decrease in electrochemical surface area at the cathode due to the growth and dissolution of platinum, flooding at the cathode due to a decrease in oxygen diffusivity, thinning of the electrolyte membrane, pinhole formation, etc. Although there are many techniques to prevent corrosion of carbon, it is impossible to completely block the flow of hydrogen to the cathode. However, it is possible to prevent the corrosion of carbon by temporarily blocking the line through which air is supplied to the cathode.

Accordingly, the electrolyte membrane which is responsible for the transfer of hydrogen ions from the anode to the cathode is very important to the durability of the fuel cell stack. Thus, it is very important to recognize and respond to the degradation of this membrane, which causes the reduction in the performance and durability of the fuel cell stack.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a method for recovering performance of a fuel cell, which can recover the catalytic properties of a cathode in a reusable state by supplying hydrogen to the cathode of a degraded fuel cell stack for a predetermined period of time and storing the fuel cell stack for a predetermined period of time so that an oxide formed on the surface of platinum (Pt) is removed and, at the same time, the platinum is re-precipitated.

In one aspect, an exemplary embodiment of the present invention provides a method for recovering performance of a fuel cell, the method including the steps of: supplying hydrogen to a cathode of a degraded fuel cell stack for a predetermined period of time and storing the fuel cell stack for a predetermined period of time; and allowing an oxide formed on the surface of a platinum catalyst of the cathode to be reduced and removed while the fuel cell stack is stored for a predetermined period of time, wherein the above steps are repeated at least three times, thus partially recovering the performance of the degraded fuel cell stack.

In the exemplary embodiment of the present invention, hydrogen at 70° C. may be supplied to the cathode of the fuel cell stack for at least 1 hour and the fuel cell stack may be stored for 2 to 3 days.

Additionally, platinum ions, from which the oxide formed on the surface of the platinum catalyst is removed, and mobile platinum ions (Pt^{z+}, x=2,4), which are released during operation of the fuel cell stack, may combine with electrons and may be re-precipitated as highly active platinum (Pt).

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic diagram showing a conventional degradation of a fuel cell;

FIG. 2 is a graphical illustration showing current-voltage characteristics according to a process of recovering performance of a fuel cell of the exemplary embodiment of the present invention;

FIG. 3 is a graphical illustration showing the cell voltage distribution according to a process of recovering performance of a fuel cell of the exemplary embodiment of the present invention;

FIG. 4 is a graphical illustration showing the degradation rate according to a process of recovering performance of a fuel cell of the exemplary embodiment of the present invention;

FIG. 5 is a graphical illustration showing the continuous operation under constant current according to a process of recovering performance of a fuel cell of the exemplary embodiment of the present invention;

FIGS. 6 and 7 are graphical illustrations showing the changes in electrochemical properties of a platinum catalyst by the supply of hydrogen in a cathode; and

FIGS. 8 and 9 are schematic diagrams showing the reduction of Pt/C oxides occurring during operation by the supply and storage of hydrogen in the cathode.

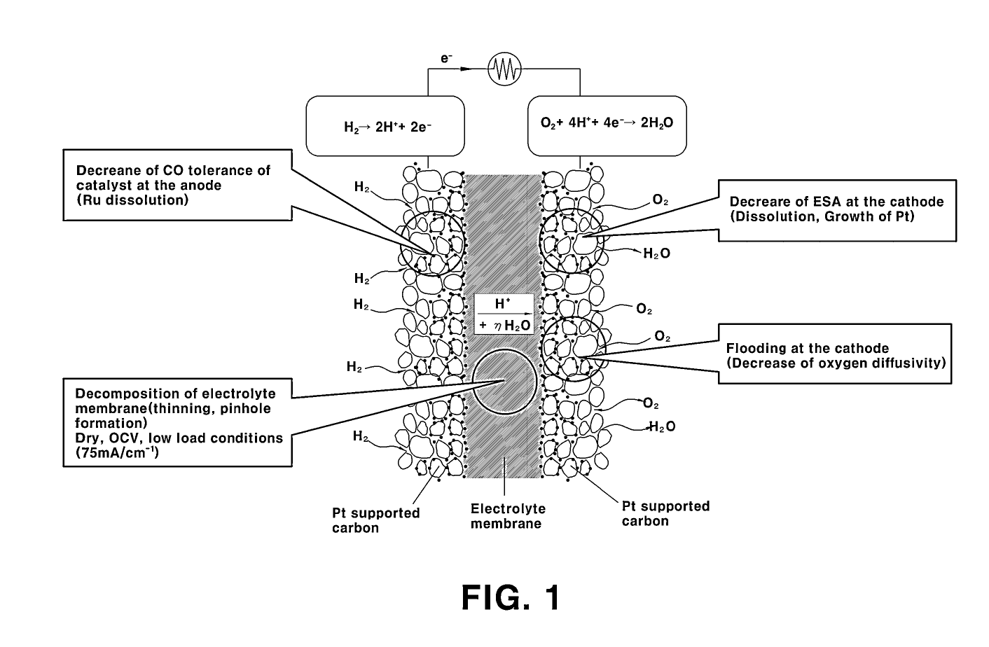

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The above and other features of the invention are discussed infra.

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The present invention is aimed at recovering degraded performance of a cathode catalyst layer of a fuel cell, which is one of various causes of the degradation in performance of a fuel cell.

To this end, the present invention provides a method for recovering performance of a fuel cell, the method including the steps of: supplying hydrogen to a cathode of a degraded fuel cell stack for a predetermined period of time and storing the fuel cell stack for a predetermined period of time (1 or more hours); and allowing an oxide formed on the surface of a platinum catalyst of the cathode to be reduced and removed while the fuel cell stack is stored for a predetermined period of time (e.g., 2-3 days), wherein the above steps are repeated more than three times, thus partially recovering the performance of the degraded fuel cell stack (e.g., by about 30 to 40%).

Preferably, according to the present invention, hydrogen at 70° C. may be supplied to the cathode of the degraded fuel cell stack for at least 1 hour, and the fuel cell stack may be stored for 2 to 3 days. A result of the above processes, an oxide formed on the surface of the platinum catalyst of the cathode may be reduced and removed over the course of the 2 to 3 day storage.

That is, when hydrogen at 70° C. is supplied to the cathode of the degraded fuel cell stack for at least 1 hour and the fuel cell stack is stored for 2 to 3 days, oxides such as PtOH, PtO, PtO₂, etc. formed on the surface of the platinum catalyst of the cathode are reduced and removed and, at the same time, platinum cation and mobile platinum ions (Pt^{z+}, x=2,4), which are released during operation of the fuel cell stack, combine with electrons (2e⁻) to produce water and are re-precipitated as highly active platinum (Pt).

Nanoscale platinum that is used as a fuel cell catalyst has a relatively large specific surface area and thus tends to be oxidized in the air as shown in the following platinum oxidation reaction and to be reduced in a hydrogen atmosphere as shown in the following platinum reduction reaction.

Platinum oxidation reaction: Pt+O²⁻→PtO+2e

Platinum reduction reaction: PtO+2H⁺+2e→Pt+H₂O

As such, the oxide films formed on the surface of the platinum catalyst are removed by the platinum reduction reaction of the cathode catalyst layer in the hydrogen atmosphere, and the metallic contact area of the catalyst layer is increased by the area where the oxide films are removed. As a result, the active site of the metallic catalyst having high catalytic activity is increased to reduce the active resistance of the electrode and increase the power output per unit cell.

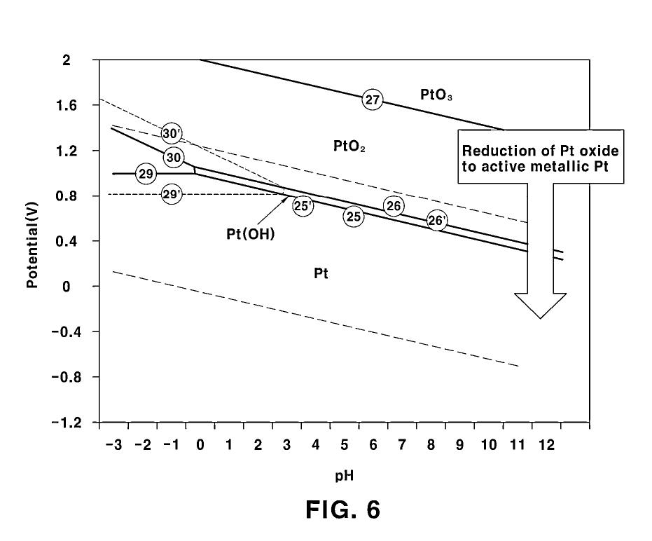

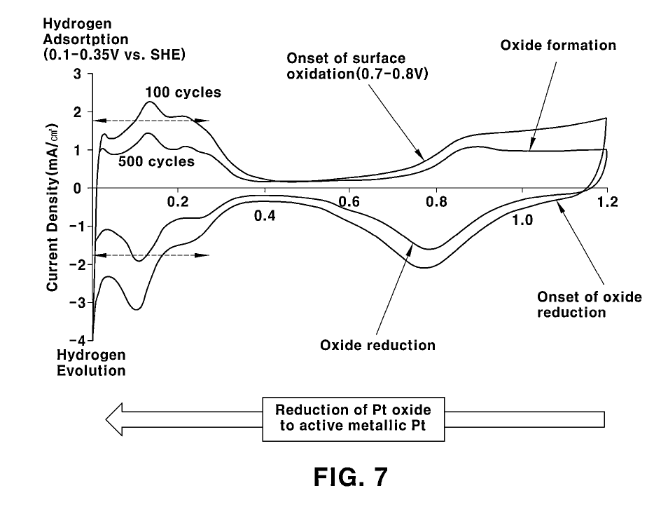

The principle that the electrochemical properties of the platinum catalyst are changed by the supply of hydrogen in the cathode will be described in more detail with reference to FIGS. 6 and 7.

FIG. 6 is a potential-pH plot of Pt which shows that the Pt metal is thermodynamically stable at a temperature below 0.7 to 0.8 V and does not corrode, but when the potential increases, oxide films such as PtOH, PtO, etc., are formed on the surface thereof.

FIG. 7 shows a cyclic voltammetry of a Pt-supported carbon electrode (Pt/C) in a 0.5 M sulfuric acid solution. When an oxide is formed on the platinum surface and the potential is scanned downward, the reduction current is observed at 1.0 V, and the reduction reaction of the surface oxides is terminated at about 0.5 V. Thus, according to the above-described method of the present invention, when the hydrogen is supplied to the cathode and stored, the cathode potential is reduced to the standard hydrogen electrode (SHE) potential, thus facilitating the reduction of oxides on the platinum surface. Moreover, it is expected that the electrochemical reduction reaction will be facilitated in a hydrogen reduction atmosphere.

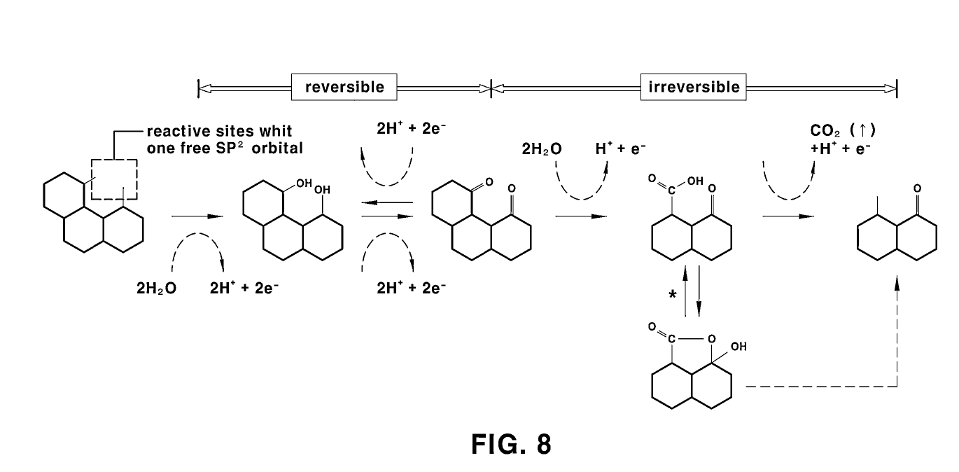

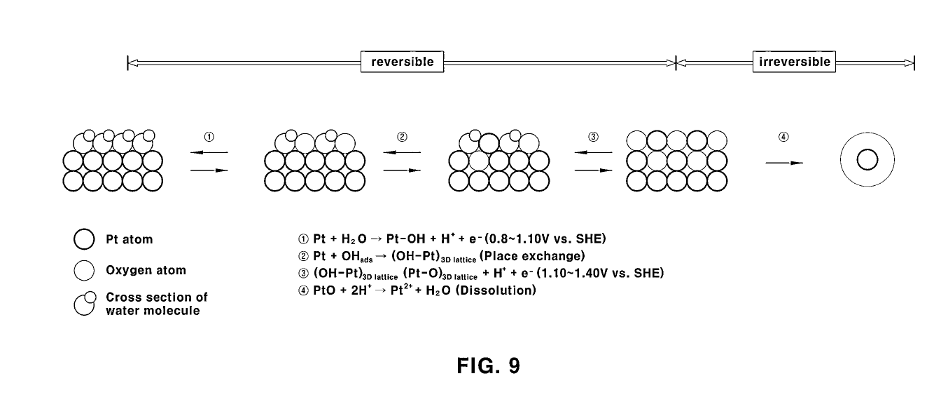

Next, the principle that the Pt/C oxides formed during the operation are reduced by the supply and storage of hydrogen in the cathode will be described in more detail with reference to FIGS. 8 and 9.

FIG. 8 shows an oxidation mechanism of carbon in a hydrogen atmosphere in the cathode of the fuel cell stack. The oxidation of carbon starts from defective sites, forms oxides such as alcohol or ether (C—OH), carbonyl (C═O), carboxyl (C—OOH), etc., and finally leads to carbon loss, thus causing the destruction of the carbon structure. A reversible reaction in the carbon oxidation reaction includes a redox reaction between C—OH and C═O (quinone-hydroquinone redox reaction). However, from the formation of a carboxyl group (COOH), an irreversible reaction by the carbon ring opening develops, and thus the reconstruction of the surface structure is impossible. Contrary to this, as shown in FIG. 9, most reactions are reversible oxidation reactions (reactions 1 to 3 of FIG. 9) until Pt is released from PtO, and when the above-described method of the present invention is carried out, it is expected that the catalytic activity of platinum can be partially recovered.

Next, the present invention will be described in more detail with reference to the following Examples.

### Examples 1 to 3

In Example 1, a process of recovering performance of a fuel cell including the step of supplying hydrogen at 70° C. to a cathode of a fuel cell stack having 217 cells, which were actually degraded and discarded, for at least 1 hour and the step of storing the fuel cell stack as it was for 2 to 3 days was repeated once.

In Examples 2 and 3, the above-described process was repeated twice and three times, respectively.

### Test Example 1

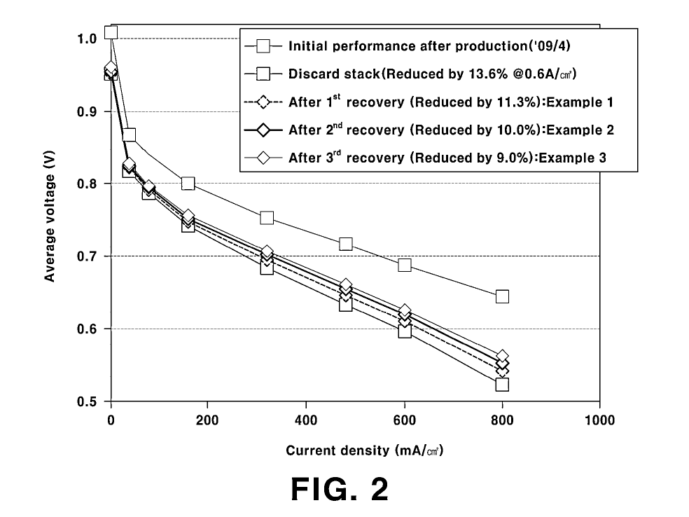

The current-voltage was measured from the fuel cell stacks in Examples 1 to 3 to compare the initial stack performance with the degraded performance, and the results are shown in FIG. 2. As can be seen from FIG. 2, the current-voltage of the degraded stack was reduced by 13.6% compared to the initial performance, but was reduced by 11.3%, 10.0%, and 9.0%, respectively, after the performance recovery process, from which it can be seen that the current-voltage generation performance of the fuel cell stack is partially recovered.

### Test Example 2

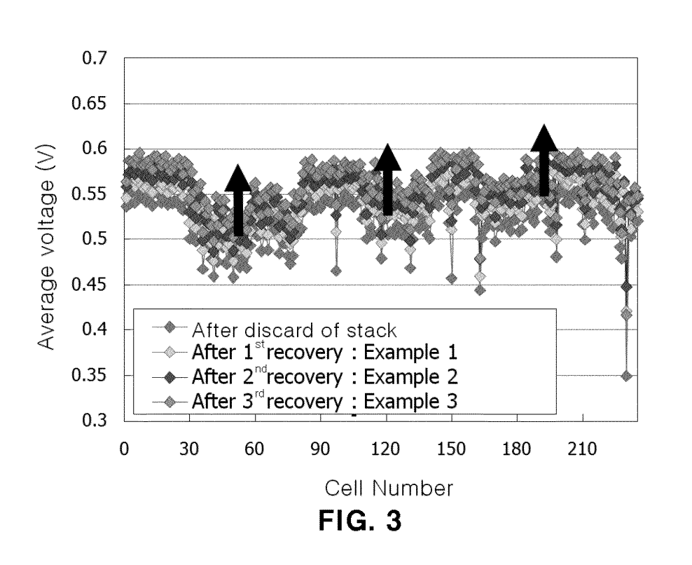

The cell voltage distribution at 0.8 A/cm² was measured from the fuel cell stacks in Examples 1 to 3 and compared with the cell voltage distribution of the degraded fuel cell stack, and the results are shown in FIG. 3. As can be seen from FIG. 3, the average cell voltage of the fuel cell stacks in Examples 1 to 3 was increased compared to that of the degraded fuel cell stack and, in particular, the average cell voltage of the fuel cell stack in Example 3 was increased by about 41 mV.

### Test Example 3

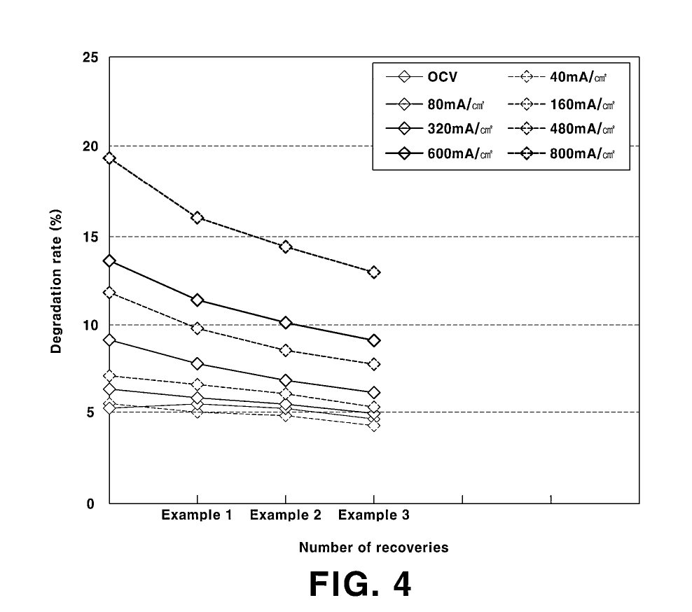

The degradation rates at various cell voltages were measured from the fuel cell stacks in Examples 1 to 3, and the results are shown in FIG. 4. As can be seen from FIG. 4, the degradation rate of the fuel cell stack was gradually reduced as the performance recovery process was carried out, which means that the durability for electricity generation is improved.

### Test Example 4

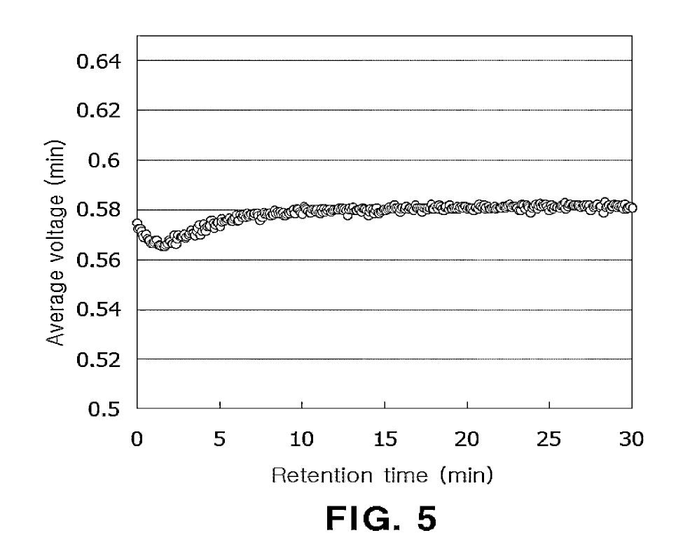

The performance recovery process was carried out three times like Example 3, and then the fuel cell stack was operated at a constant current of 0.8 A/cm², and the results are shown in FIG. 5. As can be seen from FIG. 5, the recovered voltage of 0.58 V was maintained after the operation under constant current for 30 minutes, which does not mean that the performance is temporarily recovered but means that the properties of the cathode catalyst are improved.

As described above, the present invention provides the following effects.

Since high-temperature hydrogen is supplied to the cathode of the degraded fuel cell stack caused by the irreversible degradation and the fuel cell stack is kept for a predetermined period of time, the platinum cations, from which the oxides of the platinum catalyst of the cathode are reduced and removed, and the mobile platinum ions, which are released during the operation of the fuel cell stack, combine with electrons (2e⁻) and are re-precipitated as highly active platinum (Pt), thus partially recovering the performance of the degraded fuel cell stack by about 30 to 40%. Through the above process of recovering the performance of the fuel cell stack according to the present invention, it is possible to reuse the degraded fuel cell stack and improve the durability of the fuel cell stack.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A method for recovering performance of a fuel cell, the method comprising the steps of:
supplying hydrogen to a cathode of a degraded fuel cell stack for a predetermined period of time;
storing the fuel cell stack for a predetermined period of time; and
reducing and removing an oxide formed on the surface of a platinum catalyst of the cathode by storing the fuel cell stack for a predetermined period of time,
wherein supplying, storing and reducing and removing are repeated three or more time, thus partially recovering the performance of the degraded fuel cell stack.

2. The method of claim 1, wherein hydrogen at 70° C. is supplied to the cathode of the fuel cell stack for at least 1 hour and the fuel cell stack is stored for 2 to 3 days.

3. The method of claim 1, wherein platinum ions, from which the oxide formed on a surface of the platinum catalyst is removed, and mobile platinum ions (Pt^{z+}, x=2,4), which are released during operation of the fuel cell stack, combine with electrons and are re-precipitated as highly active platinum (Pt).
